(19) United States
(12) Patent Application Publication
(10) Pub. No.: US 2007/0296920 A1
(43) Pub. Date: Dec. 27, 2007

(54) Rear Projection Screen and Associated Display System

(75) Inventors: Samir Mezouari, Brentwood (GB); Anna Taylor O'Neil, Milton Keynes (GB); Yongmin Lee, Suwon (KR); Iman Ibrahim Khandaker, Watford (GB)

Correspondence Address: WORKMAN NYDEGGER, 60 EAST SOUTH TEMPLE, 1000 EAGLE GATE TOWER, SALT LAKE CITY, UT, 84111, US

(73) Assignee: Microsharp Corporation Limited, Watchfield (GB)

(21) Appl. No.: 11/570,034

(22) PCT Filed: Jun. 7, 2005
(86) PCT No.: PCT/GB05/02218

§ 371 Date: Jun. 20, 2007

(30) Foreign Application Priority Data
Jun. 7, 2004 (GB) 0412651.2

(51) Int. Cl. G03B 21/00

(52) U.S. Cl. 353/7

(57) ABSTRACT

A rear projection display method and system, for displaying an image. The system comprises projection means (18L, 18R) to project first and second stereoscopic image components; a first light-redirecting panel (20R) and a second downstream light-redirecting panel (20L) to receive light representative of the first and second image components, respectively, from the projection means and to redirect that light substantially in a downstream direction, the first and second panels arranged to spatially multiplex the first and second image components; and a parallax optic element (22) located downstream of the second panel to provide at a downstream viewing zone (24) the first and second image components for autostereoscopic viewing of the image. The projection means may be switchable between 2D and 3D viewing modes. A 3D image may be produced by simultaneously or sequentially projecting a series of 2D image sections, using diffuser elements (45). A method of displaying a 3D image is also disclosed.

### BACKGROUND OF THE INVENTION

1. Field of the Invention

The present invention relates to a display system, and more particularly to an autostereoscopic and a volumetric image display system for displaying a three-dimensional (3D) image. The present invention concerns a 3D image projection system that does not require a viewer to wear goggles or glasses.

2. Discussion of Related Art

As is well known in the art, a 3D image can be obtained by combining two images, namely a left eye image and a right eye image, which are then processed through a suitable 3D display system. 3D display systems can be categorized by the technique used to channel the left and right images to the appropriate eye: those which require optical devices close to the viewer's eyes (such as glasses or goggles) are known as stereoscopic displays, while those which have the eye-addressing components completely integrated within the display itself are known as autostereoscopic displays.

With autostereoscopic systems, the only exploitable constraint for addressing the left and right eye respectively is the fact that the left and right eyes are spatially separated and so occupy different points in space. The wavefronts forming the 3-D image may originate from either fixed or gaze-controlled (i.e., viewer-tracked) image planes. In both cases, the content of the left and right image is channeled to the appropriate eye by means of direction-multiplexing. Compared with stereoscopic techniques, it is possible to multiplex more than two views at a time. Thus with autostereoscopic, multi-view systems it is possible to provide viewing freedom for more than one viewer.

Flat panel displays based on LCD technology have optical properties that make them ideally suited for use as autostereoscopic 3D displays. In particular, they are optically flat and have precisely positioned pixels, which allows external optical components to be added in front of or behind the displays. In this way, low-cost, high-quality, 3D autostereoscopic displays may be provided.

The parallax barrier design which uses optical apertures aligned with columns of LCD pixels is the simplest way to create a twin-view 3D display. The left and right images are interlaced in columns on the display and the parallax barrier is positioned so that left and right image pixels are blocked from view except in the appropriate viewing regions. Such display systems are disclosed in U.S. Pat. No. 6,157,424, which uses a secondary LCD to produce parallax barriers behind an imaging LCD; U.S. Pat. No. 6,055,013, which uses a parallax barrier design that blocks light, using strips of a black mask to form a plurality of viewing windows; U.S. Pat. No. 5,831,765, which employs alternating, vertical striped transmitting portions and barrier portions, each barrier portion comprising a reflecting film and a light absorbing film on opposing sides; and U.S. Pat. No. 6,239,830, in which viewing windows are steered to track the viewer in three dimensions, by varying the pitch and aperture of the parallax barriers in real time, although with limited tracking range and a relatively complex design.

The design of parallax apertures is very sensitive to diffraction effects that lead to crosstalk, which therefore constrains the minimum useful width of apertures compatible with uniform intensity at the viewing window. Other problems with parallax barriers include reduced brightness, due to blocking the light from pixels and reflections from the surface of the parallax barrier. A wider parallax aperture increases brightness, but reduces the apparent three-dimensional effect of the display. Furthermore, while placing the parallax barrier behind the LCD results in lower crosstalk, placing it in front of the LCD produces better uniformity.

Alternatively, lenticular elements may be used. In 3D displays, these are normally cylindrical lenses with their axes arranged vertically with respect to a viewer. The cylindrical lenses direct the diffuse light allowing different pixels to be redirected to either the left or right image.

EP-A-0,354,851 uses a lenticular sheet for a 3D display by combining pixels for left and right eye images, each having a binocular disparity. The pitch of each lenticular element is set to be slightly smaller than the repetitive pitch of a pair of pixels. Detection of changes in viewer position and changing the positions of the left and right eye image pixels accordingly is also disclosed.

U.S. Pat. No. 5,897,184 discloses a backlight for 2D/3D display, which uses a lightguide and lenticular elements behind an LCD display to construct a reduced-thickness backlight. The lightguide is provided with a series of grooves to generate an initial set of light lines, which are reimaged by the lenticular element to form a large number of evenly spaced light lines in front of the lightguide. The display is able to switch electronically between 2D and 3D illumination modes, using polymer dispersed liquid crystal (PDLC) as a switching diffuser. However, this design has higher crosstalk than a parallax barrier system in the 3D mode.

Some autostereoscopic displays use polarisation-based optical elements. For example, in U.S. Pat. No. 6,046,849, a 3D display is created by a front parallax barrier effect, which is made using a patterned retarder and an analyser. Micropolarisers are used to create a switchable 2D/3D display. However, this design requires very accurate construction of the patterned retarder array that is placed inside the LCD stack, if parallax problems are to be avoided.

A number of research groups have been working towards adapting the principle of holography to an LCD-based video electronics environment. For example, U.S. Pat. No. 6,590,680 discloses a technique of producing video-rate 3D images using LCD holography. However, the spatial resolution of today's LC-panels is a serious constraint. It is also difficult to store and transmit the enormous amount of data contained in a hologram. In addition, there are problems of colour fringing, due to the diffractive nature of the hologram.

An alternative means of producing 3D images is provided by volumetric display systems. In a volumetric display system, the effective origins of the wavefronts entering the observer's eyes match with the apparent spatial position of the corresponding image points. Thus, the fundamental mechanisms of spatial vision are fully supported. Exemplary volumetric display systems are disclosed in EP-A-0,928,117 and U.S. Pat. No. 6,554,430, in which image points are projected to definite loci in a physical volume of space where they appear either on a real surface, or as 2D image layers forming a stack of distinct depth planes. The refresh or repeat rate has to be sufficiently fast to avoid flickering. In some systems, phosphor persistence allows only a limited number of planes to be displayed without visible image smear. In volumetric displays the portrayed objects appear transparent, since the light energy addressed to points in space cannot be absorbed by foreground pixels.

Thus a number of 3D display systems have been developed, but their application is limited by many factors. These factors include diffraction problems from parallax apertures, complex fabrication, crosstalk, and inefficiency due to blocking of light.

There is a need therefore for an improved 3D display system. It would be desirable to provide a cost effective 3D display system that readily interfaces with a conventional 2D display format, with real-time interactivity, whilst supporting 3D autostereoscopic visualization. It would also be desirable to provide a rear projection display system which is switchable between 2D and 3D autostereoscopic images, with high optical efficiency, in a slim housing. In addition, it would be desirable to provide an improved volumetric 3D display system.

### SUMMARY OF THE INVENTION

The present invention aims to address the above and other objectives by providing an improved rear projection screen and associated display system.

According to a first aspect of the present invention, there is provided a rear projection display system, for displaying an image, the system comprising: projection means arranged to project first and second stereoscopic image components; a first light-redirecting panel arranged to receive light representative of the first stereoscopic image component from the projection means and to redirect that light substantially in a downstream direction; a second light-redirecting panel downstream of the first panel, and arranged to receive light representative of the second stereoscopic image component from the projection means and to redirect that light substantially in the downstream direction, the first and second light-redirecting panels being arranged so as to spatially multiplex the first and second image components; and a parallax optic element located downstream of the second panel and arranged to provide at a downstream viewing zone the first and second image components for autostereoscopic viewing of the image.

Autostereoscopic display systems currently on the market use a set resolution display and a parallax barrier along one dimension, which leads to a loss in resolution in the direction in which parallax is provided and also a loss in luminance/brightness of around 50%. The display system of the present invention is easily scalable to large display sizes and does not suffer from the disadvantages due to loss of brightness or resolution normally encountered by direct-view parallax barrier LCD display systems. In fact, it is possible to increase the resolution of the display system when in 2D mode, as a result of the interleaving/multiplexing of the left and right images. It is therefore possible to run the display system of the present invention in any of three modes: a standard 2D mode, a double-resolution 2D mode, and the 3D autostereoscopic mode.

According to a second aspect of the present invention, there is provided a rear projection display system, comprising: at least a first image projection means, arranged to project a plurality of 2D image sections representing a 3D image; at least a first light-redirecting panel, arranged to receive light representative of the 2D image sections and to redirect that light substantially in a downstream direction, so as to spatially multiplex each 2D image section; and a plurality of diffuser elements arranged downstream of the or each light-redirecting panel to diffuse respective multiplexed portions of each 2D section, such that the 2D image sections may be viewed downstream of the diffuser elements as the 3D image.

This aspect of the present invention provides the advantages of eliminating the need for a large scale rotating component and preventing consequent mechanical failure of components. In addition, there is no need to use layered LCD panels which typically attenuate a large amount of light.

According to a third aspect of the present invention, there is provided a rear projection display system, for displaying an image, the system comprising: a light-redirecting panel; projection means arranged to project first and second stereoscopic image components from respective opposing sides of the light-redirecting panel, the light-redirecting panel being arranged to receive light representative of the first and second stereoscopic image components from the projection means, and to redirect that light substantially in a downstream direction, so as to spatially multiplex the first and second image components; and a parallax optic element, located downstream of the light-redirecting panel and arranged to provide at a downstream viewing zone the first and second image components for autostereoscopic viewing of the image.

According to a fourth aspect of the present invention, there is provided a method of displaying a 3D image, comprising spatially multiplexing respective left and right eye stereoscopic images from an image projection means using first and second light-redirecting panels, and passing the multiplexed images through a parallax optic device such that the left and right eye images may be viewed at a viewing zone with binocular disparity.

According to a further aspect of the present invention, there is provided an autostereoscopic rear projection display system for displaying a three-dimensional image on a screen, comprising a left redirecting optical panel and a right redirecting optical panel. The redirecting optical panels are used to multiplex and spatially alternate the left eye image and right eye image, to produce visually distinct image segments containing three-dimensional information on parallel-disposed elongated stripes having substantially mutually parallel vertical axes. The autostereoscopic rear projection display system includes projectors to produce a right eye image and left eye image. In one embodiment of the present invention, a parallax optic element is used to channel the right image to the right eye, and the left image to the left eye. In addition, a display system is disclosed which is formed by a plurality of rear projection screens aligned to produce a 3D volumetric display.

The present invention also provides the following aspects and preferred features:

An autostereoscopic rear projection display system for displaying a three-dimensional image on a screen, comprising:

at least one left redirecting optical panel and at least one right redirecting optical panel, which are used to multiplex and alternate spatially the left eye image and right eye image to produce visually distinct image segments containing three-dimensional information on parallel-disposed elongated stripes having substantially mutually parallel vertical axes,

a projection system projecting a left eye image,

a projection system projecting a right eye image,

a parallax optic element.

Preferably, the left redirecting optical panel and the right redirecting optical panel redirect the said left eye image and said right eye image formed by said projection system illuminating each redirecting optical panel, wherein the said redirecting optical panel comprises:

a front planar face,

a back face having a transparent, substantially periodic structure constituted of a group of transparent facets;

a transparent first facet substantially perpendicular to the transmitted said left eye image or said right eye image, and

a transparent second planar facet adjoining said first planar facet and substantially parallel to said left eye image or said right eye image, and

a transparent third planar facet, which reflects by total internal reflection the transmitted said left eye image or said right eye image, adjoining said second planar facet, and

a fourth planar facet, which is substantially parallel to the front planar face, adjoining said third planar facet to the adjacent said first planar facet.

Preferably, the first facet of is planar, or is curved so as to focus the light it transmits.

Preferably, the said transparent third planar facet forms a suitable angle relative to said second planar facet in order to reflect the said left eye image or said right eye image so that they are redirected substantially perpendicular to the said front planar face.

Preferably, said projection system projecting a left eye image and said projection system projecting a right eye image include:

a single light source or a plurality of light sources; and

anamorphic optical elements or digital signal processing elements. These elements allow a focused image at all points across the screen and reduce field distortions, like but not limited to keystone-type and cornerstone-type distortion of the image.

Preferably, the image source is selected amongst the group consisting of Liquid Crystal Display (LCD), a Digital Micromirror Device (DMD), a laser-raster scanner, a Microelectromechanical System (MEMS), a Cathode Ray Tube (CRT), a single or an array of Light Emitting Diodes (LEDs), Organic Light Emitting Diode (OLED), or Grating Light Valve (GLV), or any other image source known to those skilled in the art.

Preferably, said parallax optical element is a lenticular sheet placed between the viewer and said redirecting optical panel.

Alternatively, said parallax optical element is a set of parallax barriers placed between the viewer and said redirecting optical panel.

Preferably, said first facet and said fourth planar facet are anti-reflection coated.

Preferably, said third planar facet is coated to enhance the said total internal reflection effect.

Preferably, said fourth planar facet is needed for the combination of said left eye image and said right eye image.

Preferably, said projection systems are projecting identical left and right eye images when two-dimensional viewing is desired.

Preferably, the left redirecting optical panel and the right redirecting optical panel redirect the said left eye image and said right eye image formed by said projection system arranged illuminating each redirecting optical panel, wherein the said redirecting optical panel comprises:

a front planar face,

a back face having a transparent, substantially periodic structure constituted of a group of transparent facets;

a transparent first planar facet substantially perpendicular to the transmitted said left eye image or said right eye image, and

a transparent second planar facet, which reflects by internal reflection the transmitted said left eye image or said right eye image, adjoining said first planar facet and said third planar facet, and

a third planar facet, which is substantially parallel to the front planar face, adjoining said second planar facet to the adjacent said first planar facet.

Preferably, the said transparent second planar facet forms a suitable angle relative to said first planar facet in order to reflect the said left eye image or said right eye image so that they are redirected substantially perpendicular to the said front planar face.

Other preferred features are set out in the description, and in the dependent claims which are appended hereto. To appreciate fully this invention, and many of its advantages, the following description will be extended in the detailed description following this section.

The present invention may be put into practice in a number of ways and some embodiments will now be described, by way of example only, with reference to the following figures, in which:

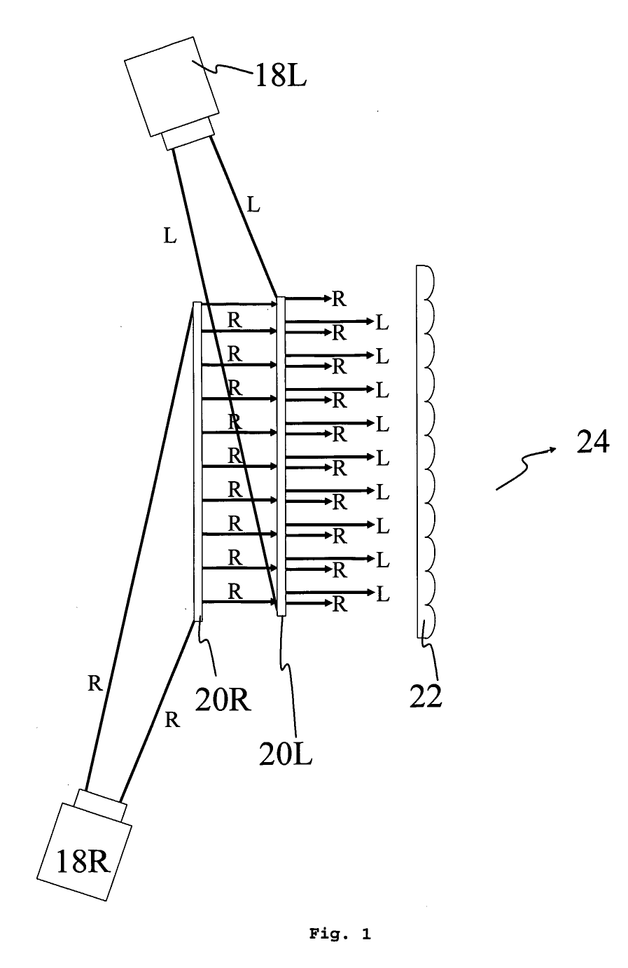

FIG. 1 shows schematically an embodiment of the present invention illustrating the multiplexing of left and right projectors for the formation of a 3D image;

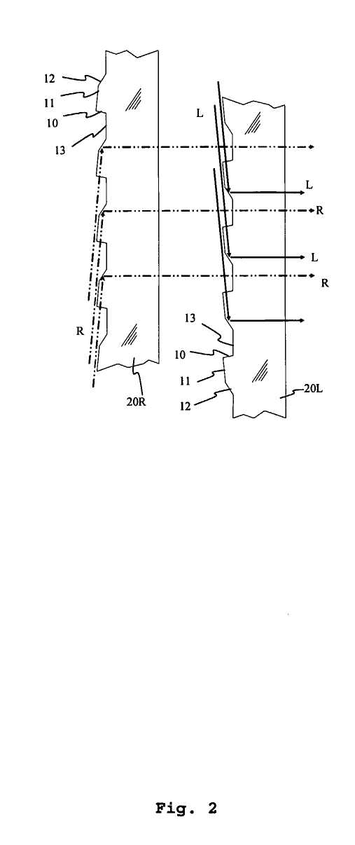

FIG. 2 shows schematically an arrangement of the two optical panels forming left and right images, in accordance with one embodiment;

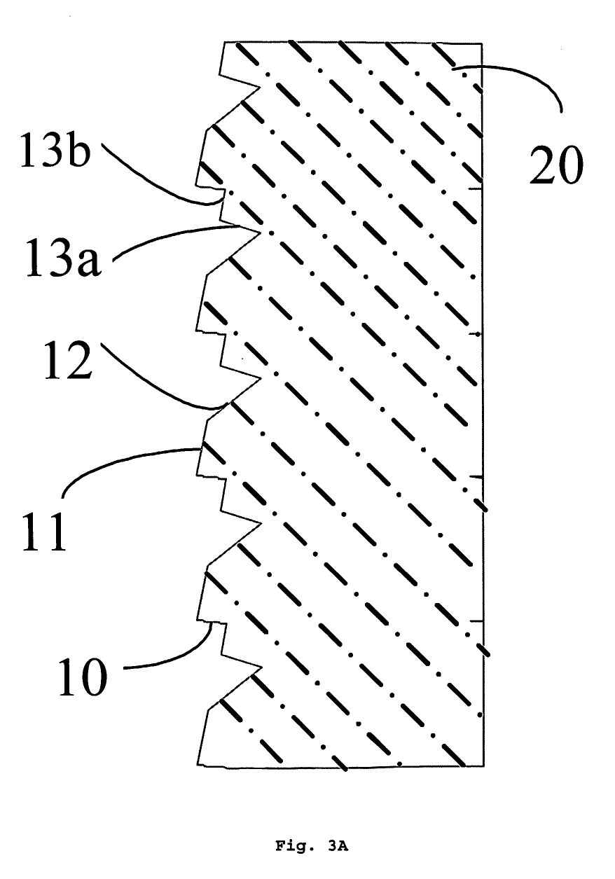

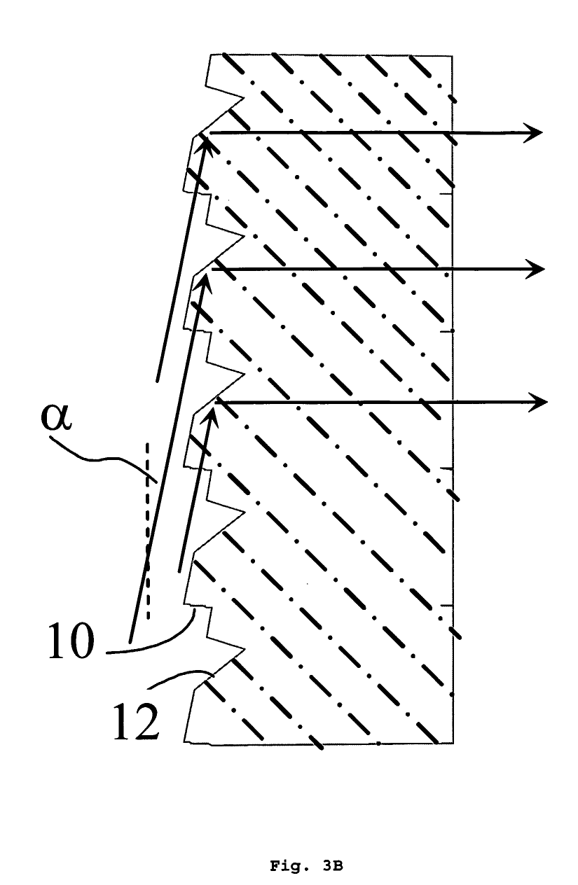

FIGS. 3A and 3B show schematically an alternative arrangement of an optical panel, in accordance with a further embodiment;

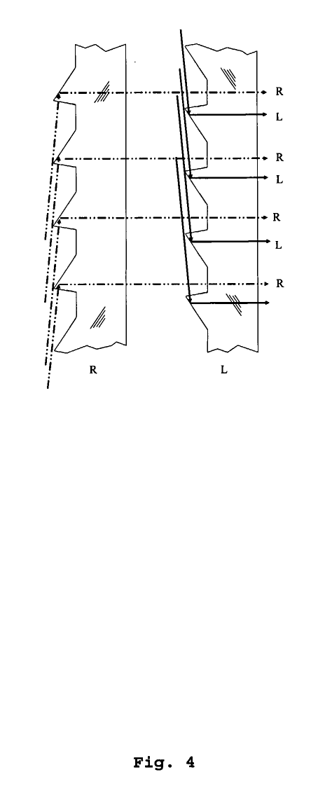

FIG. 4 shows schematically a further arrangement of the two optical panels forming left and right images, in accordance with a still further embodiment;

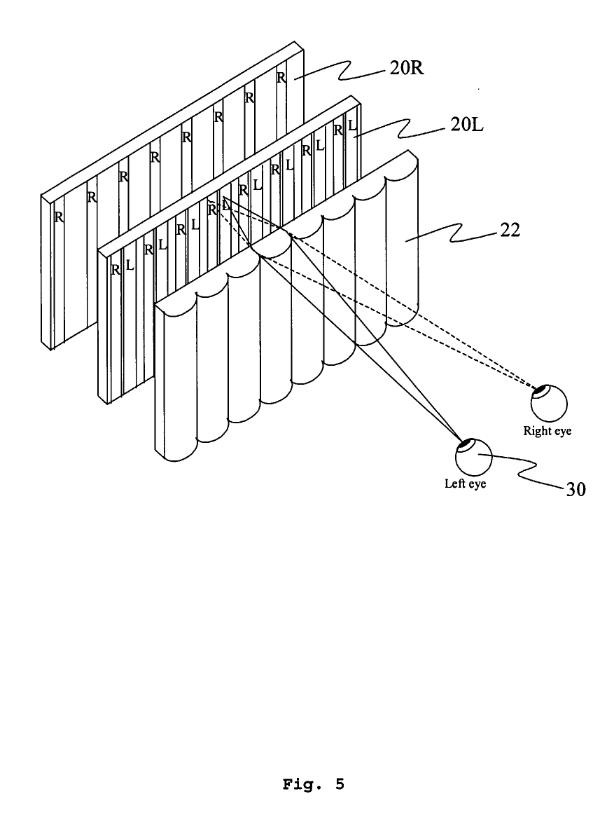

FIG. 5 shows an isometric view of an embodiment employing lenticular elements;

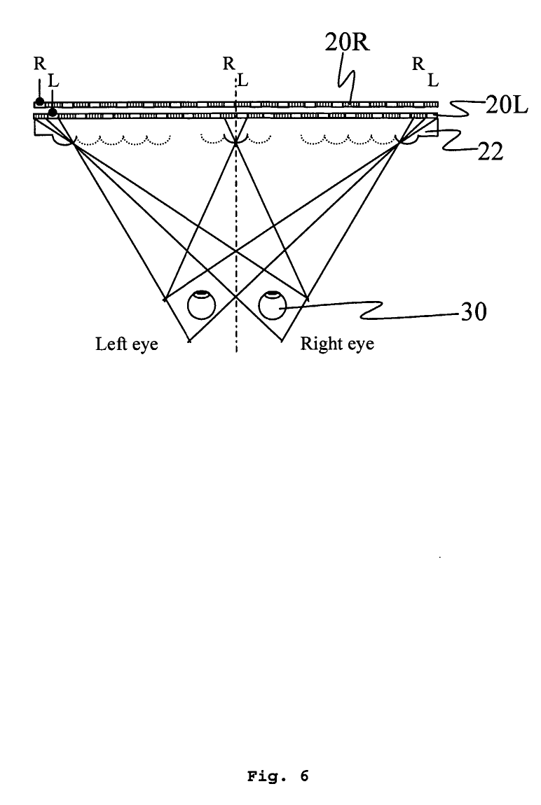

FIG. 6 shows a schematic plan view of stereo zones;

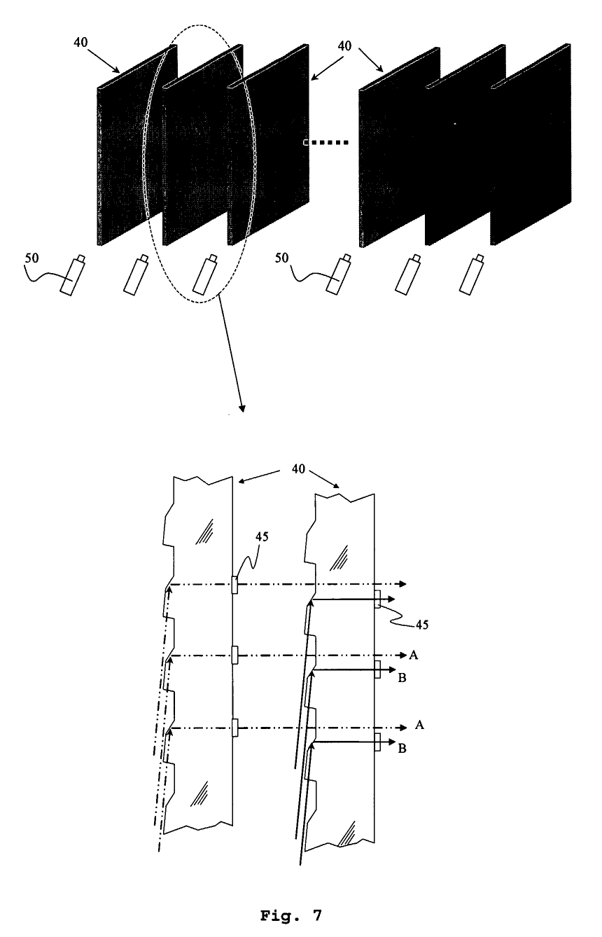

FIG. 7 shows schematically a volumetric display employing a plurality of projectors and aligned screens with diffusing elements, according to a further embodiment;

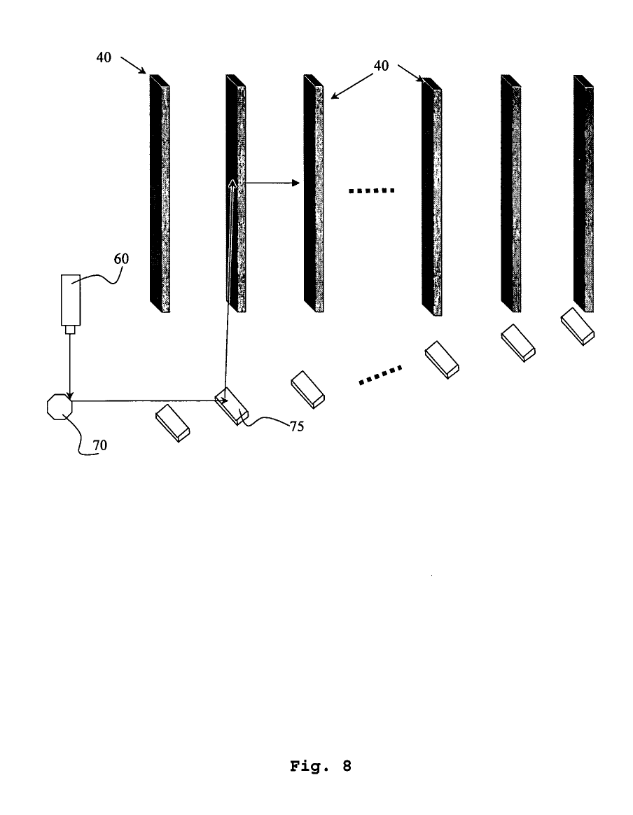

FIG. 8 shows schematically an embodiment of a volumetric display comprising a plurality of aligned screens with a scanned array of emitters/modulators;

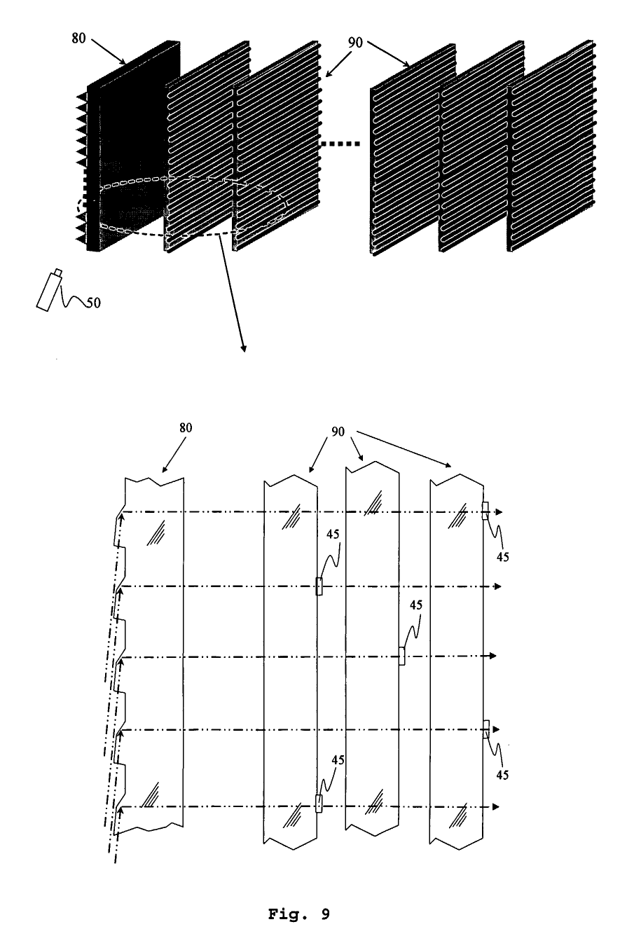

FIG. 9 shows schematically an embodiment of a volumetric display comprising a light-directing panel aligned with diffusing elements;

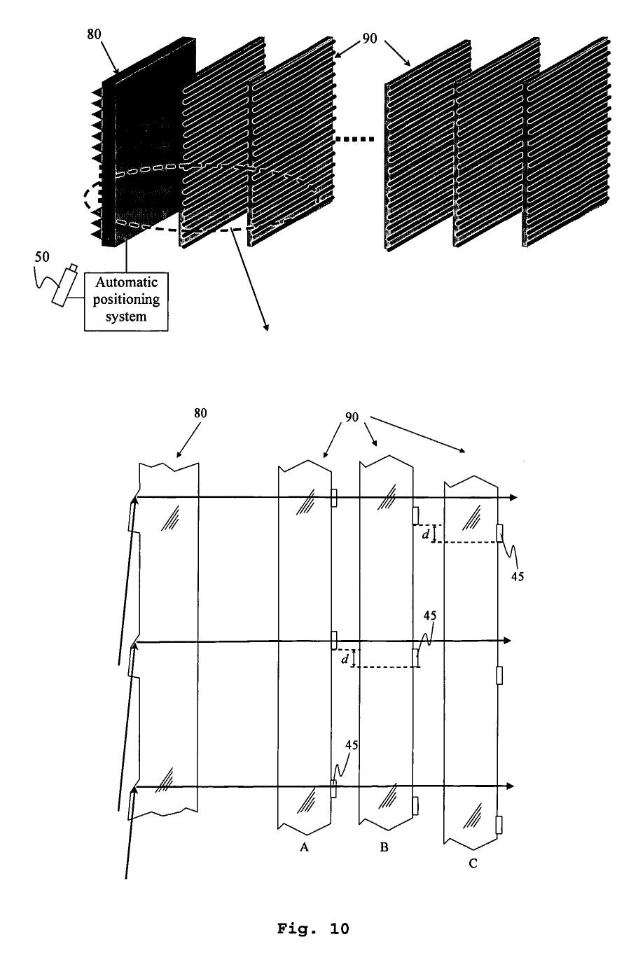

FIG. 10 shows schematically an embodiment of a volumetric display comprising a reciprocating light-directing panel;

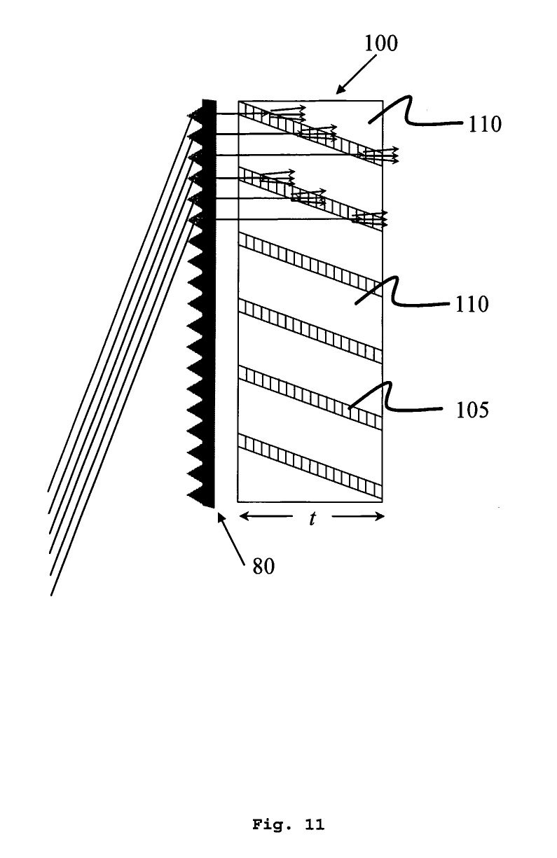

FIG. 11 shows schematically an embodiment of a volumetric display comprising a light-directing panel combined with diffusers arranged in louvred stack; and

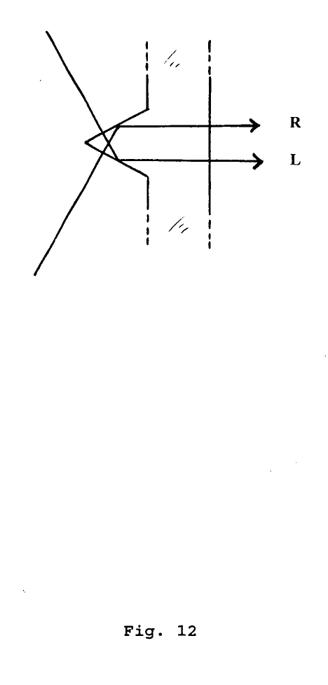

FIG. 12 shows schematically a further embodiment illustrating the multiplexing of left and right image portions using a single redirecting panel.

### DETAILED DESCRIPTION OF THE INVENTION

One aspect of the present invention provides a 3D display system which optically combines a right eye image with a left eye image to produce a 3D spatially multiplexed image.

FIG. 1 illustrates one preferred embodiment of a 3D rear projection display system that includes a left-image projector 18L, a right-image projector 18R, a right redirecting optical panel 20R, a left redirecting optical panel 20L, and a lenticular sheet 22. The right-eye image component generated by the right-image projector 18R is irradiated to the rear surface of the right redirecting optical panel 20R. Here, it is redirected towards the lenticular sheet 22 and a downstream viewing region 24. Thus, in addition to the optical panel 20R the redirected light also travels through the optical panel 20L, towards the lenticular sheet 22. Concurrently, the left-eye image component generated by the left-image projector 18L is irradiated to the rear surface of and then redirected by the left redirecting optical panel 20L, in the downstream direction towards the lenticular sheet 22.

The left and right redirected light is arranged to remain distinct upstream of the lenticular sheet 22, i.e. spatially multiplexed, so the left and right redirected light does not take the same path to the sheet, as shown in FIG. 1. The left and right stereoscopic image components are spatially multiplexed as substantially distinct, alternating left and right image portions.

The lenticular sheet 22 serves as a parallax optic element and brings the multiplexed light to the viewing region 24. Here, within the viewing region 24, a viewer may view the left and right stereoscopic components and, due to the effect of binocular disparity, the viewer sees these separate 2D images as a single 3D image.

Of course, while the above embodiment describes the left light-redirecting panel 20L as being downstream of the right light-redirecting panel 20R, the order of the panels may be changed. In this case, it is the redirected light representative of the left-eye image which passes through the right redirecting panel 20R on its way to the lenticular sheet 22.

The projectors 18L, 18R used in the described embodiments of the present invention may comprise any conventional form capable of projecting a viewing image. One such embodiment of the projector could entail, for example, the use of anamorphic optical elements or a digital signal-processing unit for reduction of field distortion (such as keystone-type, or cornerstone-type, distortion) of the image, with a suitable light source in each for producing the right-image and the left-image. This may be beneficial in reducing the effect resulting from projecting the left- and right-eye images at an acute angle with respect to the redirecting panels 20L, 20R. The projectors may be placed at either side or both sides.

The light source (not shown) may be a light bulb, slide projector, video projector, or laser. Some form of light modulator may also be included in each of the projectors 18L, 18R, to modulate the right-image and the left-image light. There are many types of modulator which can be included in different embodiments of a 3D rear projection display system. For example, the modulator may comprise, but is not limited to, one or more of the following: a conventional Liquid Crystal Display (LCD), a Digital Micromirror Device (DMD), a laser-raster scanner, a Microelectromechanical System (MEMS), a Cathode Ray Tube (CRT), a single or an array of Light Emitting Diodes (LEDs), Organic Light Emitting Diode (OLED), Grating Light Valve (GLV), a slide, a film, or any other image source known to those skilled in the art.

The projectors 18L, 18R may also include suitable imaging optics for distributing the left-image and right-image light horizontally and vertically over the rear face of each optical panel, 20L, 20R, for transmission therethrough. The imaging optics, which may include folding mirrors and/or lenses, are preferably optically aligned between the back face of each optical panel 20L, 20R and the light modulator.

In another embodiment, the projectors 18L, 18R could be situated so as to illuminate the optical panels 20L, 20R from the same side, instead of from opposite sides as shown in FIG. 1. If the projector 18L were moved to the same side as the projector 18R, optical panel 20L would need to be rotated by 180 degrees around an axis normal to the centre of the optical panel to enable the apparatus to function as intended. In either case, it is preferable for the optical panels 20L, 20R to be separated from each other sufficiently to allow the image from the projector irradiating the downstream optical panel to cover its full extent. Of course, this depends on the angle of incidence of the image light on the optical panels, but it is preferred for the light to impinge upon the optical panels at an oblique angle.

FIG. 2 illustrates the process of optically combining (multiplexing) the left eye image with the right eye image. In this figure, the rear surface of the optical panels is shown to include a repeating pattern of elongate ribs, having a characteristic profile. In this embodiment, each rib is made up of four parts (although, in general, other embodiments of at least, but not limited to, three facets are possible): a first part is a light-transmitting facet 10, which is arranged to be substantially perpendicular to the direction of incident light on the transmitting face, so as to maximise light transmission; the second part is a facet 11 which is generally parallel to the front surface of the optical panel; the third part is a light-reflecting facet 12, which is arranged to reflect the light which has entered the rib via facet 10 by means of total internal reflection and/or a light-reflecting coating on the facet; and the fourth part is a further facet 13, which is generally parallel to the front surface and serves to separate adjacent ribs from each other.

The transparent facet 10 is planar in the preferred embodiment. The incident rays of image light are arranged to be substantially perpendicular to the facet 10, which helps to reduce the formation of ghost images and losses due to Fresnel reflections. The incident angle and pitch can be chosen appropriately for optimum multiplexing of the right and left images. Preferably, the angle of incidence has a value substantially between 0 and 90 degrees, more preferably the angle of incidence has a value substantially between 0 and 60 degrees, most preferably the angle of incidence has a value substantially between 0 and 30 degrees.

Facet 11 is planar and generally parallel to the rays of the incident light. Facet 12 is planar and forms a suitable angle with facet 11 to reflect the light transmitted by facet 10 towards the lenticular lens sheet 22. The surface of facet 12 may be coated for improved reflection. Because the index of refraction of the environment external of the optical panels 20L, 20R is lower than the index of refraction of the redirecting optical panels themselves, facet 12 of the left redirecting panel 20L redirects the left-image light, and facet 12 of the right redirecting panel 20R redirects the right-image light, by total internal reflection, depending upon the specific refractive index and angle of incidence of light.

In order to maintain the left and right images as distinct and alternate images, the left and right redirected light cannot be collinear. Accordingly, the pattern of ribs on one of the optical panels 20L, 20R is offset with respect to the other (by approximately half the pitch for the ribs). Thus facet 13 in optical panel 20L is planar and is perpendicular to the light leaving optical panel 20R after its redirection. As such, the right image portions are hardly reflected upon encountering the left optical panel 20L, so the right-image is transmitted by the left optical panel. In this way, the light passing downstream of the left light redirecting panel 20L comprises alternating and substantially parallel left and right redirected light.

FIGS. 3A and 3B illustrate schematically an alternative form for the optical redirecting panel 20. The redirecting panel 20 of FIGS. 3A and 3B may be used substantially as illustrated for the upstream of the two optical panels, which may be either the left or the right light redirecting panel, but which is shown to be the right redirecting panel 20R in FIGS. 1 and 2. However, as mentioned above, it is preferable for the second of the redirecting panels (i.e., the downstream of the two) to include facets on its rear surface which are parallel to its front surface, so that the light redirected from the first redirecting panel can be transmitted through the panel substantially without deviation. In this case, therefore, facets 11 and 13b are preferably perpendicular to the light redirected from the first panel (or, in other words, facets 11 and 13b on the second, downstream panel 20 are preferably parallel to its front surface).

The panel 20 may be a rigid sheet of transparent glass or plastics, having a rear surface provided by a plurality of parallel ribs and grooves, the longitudinal extent of which runs generally perpendicular to the direction of the light rays passing to the rear surface of the panel from the image projecting means. More particularly, the rear surface may have, in section perpendicular to the planes of major extent of panel 20, and perpendicular to the longitudinal extent of the ribs and grooves, a profile or waveform, as shown in FIG. 3A or FIG. 3B, comprising a series of identical or similar elements each of which may be regarded as defining a respective rib, or lenticular prism, and an adjoining groove, each said element comprising a plurality of light segments, defined by respective faces or facets, (also referred to herein as sections), of the respective rib or groove. The ribs and grooves of the rear of panel 20 may be of constant cross-section throughout their length. In the arrangement shown, the projector 18L or 18R directs its light from one side onto the back of panel 20 and the ribs and grooves on the back of the panel run vertically.

Each rib on the rear surface of the panel 20 may include a transparent facet 10, which may be planar, or may be curved convexly to some extent in the preferred embodiment, the facet 10 extending almost perpendicular to the planes of major extent of the panel 20. More particularly, the facets 10 are substantially perpendicular to the direction of the incident light rays (see FIG. 3B) of imaging light which strike the rear surface of the panel 20 at a small angle α with respect to the planes of major extent of the panel 20. Thus, the rays of image light are substantially perpendicular to the facet 10, which prevents the existence of ghost image light.

Each rib/grove element includes, extending from the rearmost limit of facet 10, a face or section 11 which is optically non-functional and extends generally perpendicularly to facet 10 and thus parallel with the incident light rays (at least, for the first of the light redirecting panels 20; for the second panel, this facet is preferably parallel with the panel's front surface). The facet 11 extends to an internally reflective face or section 12 which slopes from facet 11 towards the front surface of the panel and terminates, in the arrangement of FIGS. 3A and 3B, in the bottom of a groove, the opposite wall of which is formed by an optically non-functional face or section 13a extending rearwardly to a yet further face or section 13a which extends, generally parallel with the front surface of the panel 20, to the edge nearest the front surface of panel 20 of the next rib/groove element. As shown in FIG. 3B, the incident light rays passing into the panel 20 through the facet 10 of such a rib/groove element are reflected, internally, i.e. within the panel, at facet 12 of that rib/groove element, to pass approximately perpendicular to the planes of major extent of the panel, (and thus approximately perpendicular to the front surface of the panel), through the panel 20 to exit through said front surface, towards the lenticular sheet 22.

The material that forms the optical display panel can be suitably selected to be transparent according to the application. The curvature of the facets 10 in the preferred embodiments controls the horizontal viewing angle of the panel display and concentrates or focuses the transmitted light in the horizontal direction. The incident angle α dictates the depth of a cabinet housing of the display system and in the present embodiment a has an acute value. Preferably, a has a value between 0 and 90 degrees, more preferably between 0 and 60 degrees, most preferably between 0 and 30 degrees. As noted, the facet 11 may be planar and parallel to the rays of the incident light. The facets 12 may also be convexly curved, for example of conical elliptical, hyperbolic, or spherical shape, or may be planar. The facets 12 form a suitable angle with respect to facets 10 to reflect the transmitted light towards the lenticular sheet 22. The surface of each facet 12 may have a light reflecting coating for better reflection. The index of refraction of the environment medium is lower than the index of refraction of optical display panel 20, and the facets 12 may redirect the image light by total internal reflection, without the need for a reflective coating, depending upon the specific refractive index and angle of incidence of light. The facets 13a and 13b, which do not intercept the light may have a curved or an arbitrary shape, but are preferably planar.

The optical panels 20L, 20R of FIG. 2 may in some embodiments be replaced with optical panels, known individually in the prior art, as shown in FIG. 4. Here, each rib comprises three parts: a transmitting facet, a reflecting facet and a separating facet.

In addition, any combination of the various optical redirecting panels 20 described above may be used together.

In other embodiments, facets 10 and 12 may be curved, to enable light focusing while the light passes through the optical panels 20L, 20R. In still other embodiments, the light-transmitting facets 10 and 13 may be coated with an anti-reflection coating to further improve transmission efficiency.

FIG. 5 shows an isometric view of an embodiment illustrating the construction of a system creating an autostereoscopic visual effect with lenticular elements 22. The spatially multiplexed image formed at the front of the optical panel 20L is selectively imaged by each of the cylindrical lenses in the lenticular sheet, in such a way that the right image segments are directed towards the right eye of a viewer 30, while the left image segments are directed towards the left eye of the viewer 30. It is preferable for the pitch of the cylindrical lenses to be approximately twice that of the left and right multiplexed image portions. In some embodiments, the pitch of each lenticular element is set to be slightly smaller than the repetitive pitch of a pair of left and right multiplexed image portions. The binocular disparity effected by the display system results in the left and right images viewed by the viewer 30 being interpreted as a single image in three dimensions.

Instead of the lenticular sheet 22, in some embodiments, it may be preferable to use a different parallax optic element, such as a parallax barrier element, diffraction grating, birefringent element, polarising element, or a holographic element.

FIG. 6 illustrates a schematic plan view of stereo zones. The region in which the left and right eyes are located is the region of greatest left/right-eye image reinforcement, so FIG. 6 shows the optimal position of the viewer 30 for appreciating the 3D effect. This can be expanded to more than one viewer, as is known in the art (see, for example, U.S. Pat. No. 6,433,930).

When a user does not wish to view images in three dimensions, this capability may be switched off and the display system will return to 2D display functionality. In this case, the left and right images produced by the projectors 18L, 18R will simply be the same, so that, even with the multiplexing of the left and right images, the image viewed by both eyes will be identical (i.e., no binocular disparity). The image will therefore appear in two dimensions.

FIG. 7 illustrates a further embodiment of the present invention, namely a volumetric display system comprising a plurality of projectors 50 and parallel, aligned light-redirecting panels 40 with diffusing elements 45. As before, each projector 50 is associated with a respective optical redirecting panel 40. Each optical panel 40 comprises horizontal strips of diffuser 45 situated at the front face of the optical panel 40. Each projector 50 generates a 2D image representative of a slice or section of the 3D image to be displayed corresponding to the position, or depth, of the projector. In this way, the sequence of the projectors 50 corresponds to increasing/decreasing depth of the 3D image, so the volumetric 3D image is able to preserve depth information. In operation, each projector 50 illuminates the back face of its associated optical panel 40, which directs by internal reflection the projected image toward the viewer, in a downstream direction, as before. This may be performed either sequentially for each panel and projector combination, or simultaneously. In either case, the diffuser elements 45 on each respective redirecting panel 40 intercept and diffuse the light which is redirected through that panel's ribs, so that the 2D image section formed by the array of diffuser elements on the particular panel is registered by a viewer as emanating from the depth location occupied by the panel.

The diffuser elements 45 may be formed by structured diffusers, holographic diffusers, etc., but preferably by switchable diffusers (such as LCD elements).

When the 2D image sections are displayed sequentially (which sequence may be either from panel-to-adjacent panel, or any repeating pattern which addresses each panel once per cycle), the diffuser elements 45 are preferably switchable diffusers. Such switchable diffuser elements then allow a relatively large number of light redirecting panels 40 to be used, since the problem of the rearmost viewing cones from the diffuser elements 45 on the first, upstream panel 40 impinging on subsequent diffusion elements can be avoided. That is, only the diffuser elements 45 on the redirecting panel 40 which is being addressed are switched ‘on’ to diffuse redirected light incident upon them; the diffuser elements 45 on the remaining redirecting panels 40 are switched ‘off’ and are simply then transparent optical elements, which allow the light to pass through without further diffusion. Accordingly, redirected light intercepts a strip of diffuser 45 only once during its passage through the optical panels. Light which is diffused by any particular diffuser element 45 in the array of optical panels 40 thus appears to originate from the location of that diffuser element (rather than from infinity or any other location in the display system). In this way, the viewer is able to perceive the depth effect of the volumetric display system.

As will be understood, when light is diffused from an element 45 on an optical panel 40, the light leaves the element in a generally cone-shaped profile. Thus, when displaying the 2D images simultaneously, diffuser elements 45 on adjacent panels are positioned progressively further away vertically from that element, because of the problem of early light cones hitting subsequent diffuser elements. Simultaneous volumetric display systems are therefore restricted in the total number of light redirecting panels 40 which may be usefully provided. Typically, the number is around four.

In an alternative embodiment to that shown in FIG. 7, some of the projectors 50 are situated on the opposite side to the other projectors 50, as opposed to all the projectors being on the same side, as in FIG. 7.

Practically, it is relatively difficult to implement the volumetric display system shown in FIG. 7, since aligning a large number of optical panels 40 is not straightforward. A modification of the embodiment of FIG. 7 is shown in FIG. 8. Here, an emitter/modulator 60 is used to scan at high rate the respective 2D image section for each of the plurality of optical panels 40, by means of controlled rotating and folding mirrors, 70 and 75 respectively. The projector 60 generates a series of 2D sectional images of the 3D image which is to be displayed. As the rotating mirror 70 turns, the projected images are reflected, but in a scanning action as a result of the varying angle of incidence caused by the mirror rotation. The projector 60 therefore projects the 2D images in scanned portions which are produced by scanning through each 2D image from bottom to top or vice versa. The rotating mirror is shown in FIG. 8 as having a polygonal cross-section, but may take any appropriate form. In this embodiment, the folding mirror 70 is shown as an octagonal cylinder, having a length (i.e., distance from its left to right octagonal ends) which is preferably at least the same length as the optical panels. The projector 60 and rotating mirror 70 are arranged so that the time taken for the projector to scan a 2D image is equal to the time taken for the mirror to rotate through 45 degrees (⅛ of a full rotation). In this way, one rectangular face of the rotating mirror 70 is made to reflect a single scanned 2D image from the projector 60. Each folding mirror 75 in turn intercepts the reflected and scanned image from the rotating mirror 70, as a result of which, that scanned image is reflected from the folding mirror and scanned over the rear surface of its respective light-redirecting panel 40, vertically either from top to bottom or bottom to top of the panel. For each respective 2D section of the 3D image, the next folding mirror 75 and associated panel 40 receive the image component, which is then redirected generally perpendicularly to the front and rear surfaces of the panels 40, in a downstream direction towards the viewing region 24. Thus the 2D sections of the overall image are displayed sequentially (or in any suitable repeated order) on the optical panels 40 and diffused by diffuser elements 45 located on the front surfaces of the panels, so that the desired depth perception may be achieved and the 3D image may be observed.

Of course, the folding mirror 70 may have a number of sides less than or more than eight, or may take a different form altogether, depending on the particular application and associated projection considerations.

However, the embodiment shown in FIG. 8 still requires the alignment of a large number of optical panels 40 as does the previous embodiment shown in FIG. 7. Having said that, better resolution can be achieved with the embodiment of FIG. 8 than with that of FIG. 7.

A further embodiment illustrating a volumetric display system is shown in FIG. 9. Here, an optical redirecting panel 80 is used in combination with a plurality of panel diffusers 90. The optical panel 80 directs the light projected upon it by the projector 50 by total internal reflection towards the viewer, as described above. The redirected light is then diffused by the strips of diffuser 45 that are arranged in such a way that each panel 90 diffuses a specific section of the volumetric 3D image, as shown in FIG. 9. The image projected on the optical panel 80 is a combination of multiple sections of a volumetric image in such a way that each horizontal strip of diffuser 45 will diffuse the correct section of the 2D image. Accordingly, the viewer is able to perceive the depth effect of the volumetric display system.

In this embodiment, the projector 50 is arranged to project the entire 3D volumetric image at the same time, as spatially multiplexed image lines or strips. Associated with each rib of the redirecting panel 80 is a respective diffuser element 45 from each respective panel diffuser 90. Thus, each rib receives from the projector 50 a respective array of image lines, each respective one of the image lines in the array being redirected by the rib and diffused by a different one of its associated diffuser elements 45. Each rib therefore is able to redirect light which is intended for diffusion at different image depths throughout the display. Conversely, different ribs are arranged to redirect light (respective image lines) to different diffuser elements 45 in the same depth plane (for example, the rearmost panel diffuser 90 receives light from the lowest and the second highest ribs in the redirecting panel 80 shown in FIG. 9).

In practice, the number of panel diffusers 90 used in this embodiment is around four or five, but this number may be up to 20 exceptionally.

As an alternative to simultaneous projection by the projector 50, the projector may scan the image lines/sections.

FIG. 10 shows another 3D display system that operates in a similar manner to that shown in FIG. 9. This display has an automatic positioning system driven by a servo motor or some other electronic or mechanical positioning system. The position is controlled and synchronised with the projector 50 to propagate and diffuse the temporally multiplexed images through a plurality of aligned diffusing elements, which vary uniformly from panel to panel. The optical panel 80 is vibrated or reciprocated vertically, to form an image on the array of strips of diffuser 45 on each panel diffuser 90 in turn. This activates each set of diffuser strips 45 in sequence, from panel diffuser A 90, to panel diffuser B, and then panel diffuser C, etc. Thus, the 2D image section projected by the projector 50 is changed in synchrony with the positional change of the redirecting panel 80, so that each panel receives its appropriate 2D image section. The vertical distance or pitch, d, between corresponding diffuser elements 45 on adjacent panel diffusers 90 may be equal to the height of an individual diffuser element. Alternatively, d may be greater than the height, to take into account the cone-shaped diffusion profile of the diffused redirected light. If the diffuser elements 45 are switchable, d may be less than the height.

To avoid the alignment issue which exists with the volumetric display systems discussed above, another embodiment is illustrated in FIG. 11. Here, a light-redirecting optical panel 80 is used in combination with structured diffusers 105, which are arranged in a louvred stack or sloping stacked array 100. Each redirected ray of light propagates within the diffusers 105 arranged in the louvred stack 100 and experiences a single diffusion when it intercepts a diffuser strip. As shown in FIG. 11, the diffuser strips are arranged in diagonal slices. The diffusion of light along the thickness, t, of the stack 100 allows the viewer to perceive the depth of the 3D volumetric image. The projection system is arranged to project the whole image simultaneously, as with the embodiment described with reference to FIG. 9. However, in this case, the limitation on the number of arrayed image lines per rib (corresponding to the number of downstream panel diffusers 90) is not such a concern, since the louvred diffuser elements 105 form substantially continuous slices of diffuser. The projected image lines/sections may be produced by a single projector, or by multiple projectors. The volumetric image is formed either by scanning different images or by projecting a single (2D) image containing the depth information by spatially multiplexing.

The thickness, t, of the louvred stack 100 may be in the range of 0.5 centimetres to 300 centimetres; more preferably, the thickness, t, is in the range of 0.5 centimetres to 100 centimetres. This large range can be achieved, but increases in the thickness are at the expense of image resolution. For this reason, it is preferred to employ multiple projectors, which serves to mitigate such losses in resolution.

While some of the above embodiments have been described as comprising two redirecting optical panels for autostereoscopic viewing, it is possible to provide only one optical panel, as shown in FIG. 12. In this case, the panel comprises ribs, each of which is arranged to channel both the left-eye image and the right-eye image, from the respective projectors 18L, 18R. Providing the projectors on opposite sides of the panel is necessary in this particular embodiment in order to keep the left and right images separate from each other. In this way, both sides of each rib are used for external transmission and internal reflection of the light. FIG. 12 illustrates this alternative, showing a single rib from the light redirecting panel 20.

The examples given herein are presented to enable those skilled in the art to more clearly understand and practice the invention. The examples should not be considered as limitations upon the scope of the invention, but as merely illustrative. Numerous modifications and alternative embodiments of the invention will be apparent to those skilled in the art, in view of the foregoing description, and the following claims are intended to cover all such modifications and variations.

1. A rear projection display system, for displaying an image, the system comprising:
projection means arranged to project first and second stereoscopic image components;
a first light-redirecting panel arranged to receive light representative of the first stereoscopic image component from the projection means and to redirect that light substantially in a downstream direction;
a second light-redirecting panel downstream of the first panel, and arranged to receive light representative of the second stereoscopic image component from the projection means and to redirect that light substantially in the downstream direction, the first and second light-redirecting panels being arranged so as to spatially multiplex the first and second image components; and
a parallax optic element located downstream of the second panel and arranged to provide at a downstream viewing zone the first and second image components for autostereoscopic viewing of the image.

2. The display system of claim 1, wherein the first and second image components are spatially multiplexed as a plurality of alternate and separate first and second component portions.

3. The display system of claim 1, wherein the first and second light-redirecting panels respectively comprise a rear surface on which is disposed a plurality of elongate ribs, each rib comprising a first, light-transmitting external face and a second, light-reflecting internal face, such that light incident on the first face of a rib generally obliquely with respect to the panel is transmitted into that rib and reflected at the second face substantially in the downstream direction.

4. The display system of claim 3, wherein the second, internal face is arranged at a suitable angle relative to the first, external face in order to redirect the light in a direction substantially perpendicular to a front surface of the optical panel.

5. The display system of claim 3, wherein the first plurality of ribs disposed on the first panel and the second plurality of ribs disposed on the second panel are spatially offset with respect to one another, such that respective portions of light redirected from the first panel do not take the same path as those portions redirected from the second panel.

6. The display system of claim 5, wherein the second panel further comprises a plurality of third faces respectively separating adjacent ribs, such that light redirected from the first panel is incident upon the third faces.

7. The display system of claim 6, wherein the third faces are formed substantially perpendicular to the downstream direction, so that light redirected from the first panel is substantially transmitted through the second panel.

8. The display system of claim 3, wherein the second, internal face of each rib has a light-reflecting coating thereon.

9. The display system of claim 3, wherein the first, external face has an anti-reflection coating thereon.

10. The display system of claim 6, wherein each third face has an anti-reflection coating thereon.

11. The display system of claim 3, wherein one or both of the first and second faces may be curved.

12. The display system of claim 1, wherein the projection means comprises a first image projection means arranged to project the first stereoscopic image component to the first light-redirecting panel and a second image projection means arranged to project the second stereoscopic image component to the second light-redirecting panel.

13. The display system of claim 12, wherein the first and second projection means are arranged to project the stereoscopic images to the first and second panels respectively either from the same side of the panels, or from opposite sides.

14. The display system of claim 12, wherein the first and second image projection means comprise:
either a single light source or a plurality of light sources, and
either one or more anamorphic optical elements or a digital signal processing unit, for the reduction of field distortion of the image.

15. The display system of claim 12, wherein the first and second image projection means comprise a respective image source, selected from the group consisting of: a Liquid Crystal Display (LCD), a Digital Micromirror Device (DMD), a laser-raster scanner, a Microelectromechanical System (MEMS), a Cathode Ray Tube (CRT), a single or an array of Light Emitting Diodes (LEDs), an Organic Light Emitting Diode (OLED), or Grating Light Valve (GLV), a slide, a film, or the like.

16. The display system of claim 1, wherein the parallax optic element is selected from the list comprising: a lenticular element, a parallax barrier element, a diffraction grating, a birefringent element, a polarising element, and a holographic element.

17. The display system of claim 1, wherein the projection means is switchable between a first, 3D viewing mode, and a second, 2D viewing mode in which the projection means is arranged to project first and second image components which are identical.

18. A rear projection display system, for displaying an image, the system comprising:
a light-redirecting panel;
projection means arranged to project first and second stereoscopic image components from respective opposing sides of the light-redirecting panel,
the light-redirecting panel being arranged to receive light representative of the first and second stereoscopic image components from the projection means, and to redirect that light substantially in a downstream direction, so as to spatially multiplex the first and second image components; and
a parallax optic element, located downstream of the light-redirecting panel and arranged to provide at a downstream viewing zone the first and second image components for autostereoscopic viewing of the image.

19. The display system of claim 18, wherein the light-redirecting panel comprises a rear surface on which is disposed a plurality of elongate ribs, each rib having opposed, first and second light-transmitting external faces and opposed, first and second light-reflecting internal faces, such that light representative of the first and second stereoscopic images and incident on the respective first and second transmitting faces generally obliquely with respect to the panel is transmitted into that rib and reflected at the first and second reflecting faces substantially in the downstream direction.

20. A rear projection display system, comprising:
at least a first image projection means, arranged to project a plurality of 2D image sections representing a 3D image;
at least a first light-redirecting panel, arranged to receive light representative of the 2D image sections and to redirect that light substantially in a downstream direction, so as to spatially multiplex each 2D image section; and
a plurality of diffuser elements arranged downstream of the or each light-redirecting panel to diffuse respective multiplexed portions of each 2D section, such that the 2D image sections may be viewed downstream of the diffuser elements as the 3D image.

21. The display system of claim 20, wherein the projection means is arranged to project the plurality of 2D image sections sequentially.

22. The display system of claim 20, wherein the projection means is arranged to project the plurality of 2D image sections simultaneously.

23. The display system of any of claim 20, wherein the diffuser elements are arranged such that only one diffuser element occupies any particular vertical location.

24. The display system of any of claim 20, wherein redirected light is diffused only once as it passes through the display system.

25. The display system of claim 20, wherein the diffuser elements are switchable between a diffusive state and a transparent state.

26. The display system of claim 20, comprising a plurality of parallel light-redirecting panels and a respective projection means associated with each panel, each projection means being arranged to project a respective 2D section of the 3D image according to its relative position with respect to the other of the projection means.

27. The display system of claim 26, wherein each of the light-redirecting panels comprises a respective plurality of diffuser elements disposed on its downstream surface.

28. The display system of claim 20, comprising a plurality of parallel light-redirecting panels, and a light-directing means arranged such that each 2D section is projected over a rear surface of its respective panel for redirection in the downstream direction.

29. The display system of claim 28, wherein the light-directing means comprises a plurality of folding mirror elements respectively associated with each panel, and a rotating mirror element arranged sequentially to scan a respective 2D section of the image from the image projection means onto a respective folding mirror element, so as to scan the 2D image over the rear surface of the panel.

30. The display system of claim 20, comprising a light-redirecting panel, and plurality of panel diffusers arranged parallel with one another and downstream of the light-redirecting panel, each panel diffuser having a respective plurality of diffuser elements arranged thereon such that a different 2D section of the image is diffused by each panel diffuser.

31. The display system of claim 30, wherein the projection means is arranged to project the 2D image sections onto a rear surface of the light-redirecting panel simultaneously as a set of compressed 2D image sections.

32. The display system of claim 30, wherein the locations of the diffuser elements on a first panel diffuser are varied in regular steps for adjacent panel diffusers.

33. The display system of any of claim 30, wherein the light-redirecting panel is arranged to be reciprocated, so that the 2D sections are addressed sequentially to the diffuser elements on each panel diffuser.

34. The display system of claim 20, wherein the diffuser elements are arranged in a louvred array of stacked diffuser elements.

35. The display system of claim 34, wherein a thickness of the louvred stacks is in the range of approximately 0.5 cm to 300 cm.

36. The display system of any of claim 20, wherein the 2D sections are scanned in any of a vertical, horizontal, or up/downstream direction.

37. The display system of claim 20, wherein the at least one light-redirecting panel comprises a rear surface on which is disposed a plurality of elongate ribs, each rib comprising a first, light-transmitting external face and a second, light-reflecting internal face, such that light incident on the first face of a rib generally obliquely with respect to the panel is transmitted into that rib and reflected at the second face substantially in the first direction.

38. The display system of claim 37, wherein the second, internal face is arranged at a suitable angle relative to the first, external face in order to redirect the light in a direction substantially perpendicular to a front surface of the optical panel.

39. The display system of claim 37, wherein the first plurality of ribs disposed on the first panel and subsequent pluralities of ribs disposed on the subsequent panels are spatially offset with respect to one another, such that respective portions of light redirected from the first panel do not take the same path as those portions redirected from the subsequent panels.

40. The display system of claim 39, wherein, apart from the light-transmitting and light-redirecting faces, the rear surfaces of the subsequent panels comprise a respective plurality of surfaces substantially perpendicular to the downstream direction, such that light redirected from the first and subsequent panels is substantially transmitted through the subsequent panels.

41. The display system of any of claim 37, wherein the second, internal face of each rib has a light-reflecting coating thereon.

42. The display system of claim 37, wherein the first, external face has an anti-reflection coating thereon.

43. The display system of claim 40, wherein each surface has an anti-reflection coating thereon.

44. The display system of claim 37, wherein one or both of the first and second faces may be curved.

45. The display system of claim 20, wherein the first and subsequent projection means are arranged to project the 2D sections to the first and subsequent panels respectively either from the same side of the panels, or from opposite sides.

46. The display system of claim 20, wherein the first and/or subsequent image projection means comprise:
either a single light source or a plurality of light sources, and
either one or more anamorphic optical elements or a digital signal processing unit, for the reduction of field distortion of the image.

47. The display system of claim 20, wherein the first and subsequent image projection means comprise a respective image source, selected from the group consisting of: a Liquid Crystal Display (LCD), a Digital Micromirror Device (DMD), a laser-raster scanner, a Microelectromechanical System (MEMS), a Cathode Ray Tube (CRT), a single or an array of Light Emitting Diodes (LEDs), an Organic Light Emitting Diode (OLED), or Grating Light Valve (GLV), a slide, a film, or the like.

48. A method of displaying a 3D image, comprising spatially multiplexing respective left and right eye stereoscopic images from an image projection means using first and second light-redirecting panels, and passing the multiplexed images through a parallax optic device such that the left and right eye images may be viewed at a viewing zone with binocular disparity.

49. The method of claim 48, further comprising extending the viewing zone horizontally and/or vertically by employing diffuser or lenticular elements within the display.

50-51. (canceled)
